(19) United States
(12) Patent Application Publication
(10) Pub. No.: US 2008/0256854 A1
(43) Pub. Date: Oct. 23, 2008

(54) Plant growth system

(76) Inventor: Ryan McIlvenna, Hanmer (CA)

Correspondence Address: MIKE M. GAUTHIER, 355 GOODWILL DRIVE, BOX 400, GARSON, ON, P3L 1S7, CA

(21) Appl. No.: 11/785,932

(22) Filed: Apr. 23, 2007

(51) Int. Cl. A01G 13/02

(52) U.S. Cl. 47/29.5; 340/309.8

(57) ABSTRACT

A system for mechanically simulating the daylight/dark cycle plants receive. In particular, flowering plants were ripeness is determined when said plants flower. The present system utilizes a multi arch device having a fabric laid over said arch assembly and said fabric comprising sufficient material to extend 360 degrees about a central axis. One half of this material is opaque so as to fully block daylight and the other semi-transparent so as to allow light therethrough. The device rests on the earth in which plants are grown thus half of the fabric is gathered to one side and the other in extended over an array of arches to form a dome-like covering. One central arch is mechanically operable on a timer program so as to simulate shorter days thereby fooling the plant that fall has arrived.

### FIELD OF THE INVENTION

The present invention relates to a system for mechanically simulating the daylight/dark cycle plants receive. In particular, flowering plants were ripeness is determined when said plants flower. The present system utilizes a multi arch device having a fabric laid over said arch assembly and said fabric comprising sufficient material to extend 360 degrees about a central axis. One half of this material is opaque so as to fully block daylight and the other semi-transparent so as to allow light therethrough. The device rests on the earth in which plants are grown thus half of the fabric is gathered to one side and the other in extended over an array of arches to form a dome-like covering. One central arch is mechanically operable on a timer program so as to simulate shorter days thereby fooling the plant that fall has arrived.

### BACKGROUND OF THE INVENTION

Plant growth and cultivation has been the topic of many innovations in the last decade, where crop count and plant quality have been front-of-mind for these innovations. The problem is, these innovation use indoor, artificial conditions and electric lighting to fool the plants.

Nature gives unarguably the best conditions for life in general, and plants are no different when it comes to what is best.

It is certainly desirable for growers to utilize natural soil and daylight in their quest for the perfect plant.

### SUMMARY OF THE INVENTION

It is thus the object of the present invention to provide growers with a system for simulating daylight duration using natural soil and light.

In one aspect of the invention, there is provided ventilation device to continually provide fresh air within the enclosed arched fabric.

In another aspect of the invention, the daylight half of the fabric may be either screened or clear impermeable material.

Accordingly, the device of the present invention provides growers with the best quality lighting, fully adjustable daytime duration, and an insect-reduced environment.

The utility of this device includes but is not limited to flowering plants.

### BRIEF DESCRIPTION OF THE DRAWINGS

These and other advantages of the invention will become apparent upon reading the following detailed description and upon referring to the drawings in which:—

FIG. 1 is a rear elevation view of the dome of the plant growth system of the present invention shown in a substantially transparent attitude.

FIG. 2 is a rear elevation view of the dome of the plant growth system of the present invention shown in a half darkening and half transparent attitude.

FIG. 3 is a rear elevation view of the dome of the plant growth system of the present invention shown in a substantially darkening attitude.

FIG. 4 is a front perspective view from above of the dome of the plant growth system of the present invention shown in a transparent attitude.

FIG. 5 is a front perspective view from above of the dome of the plant growth system of the present invention shown in a substantially darkening attitude.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

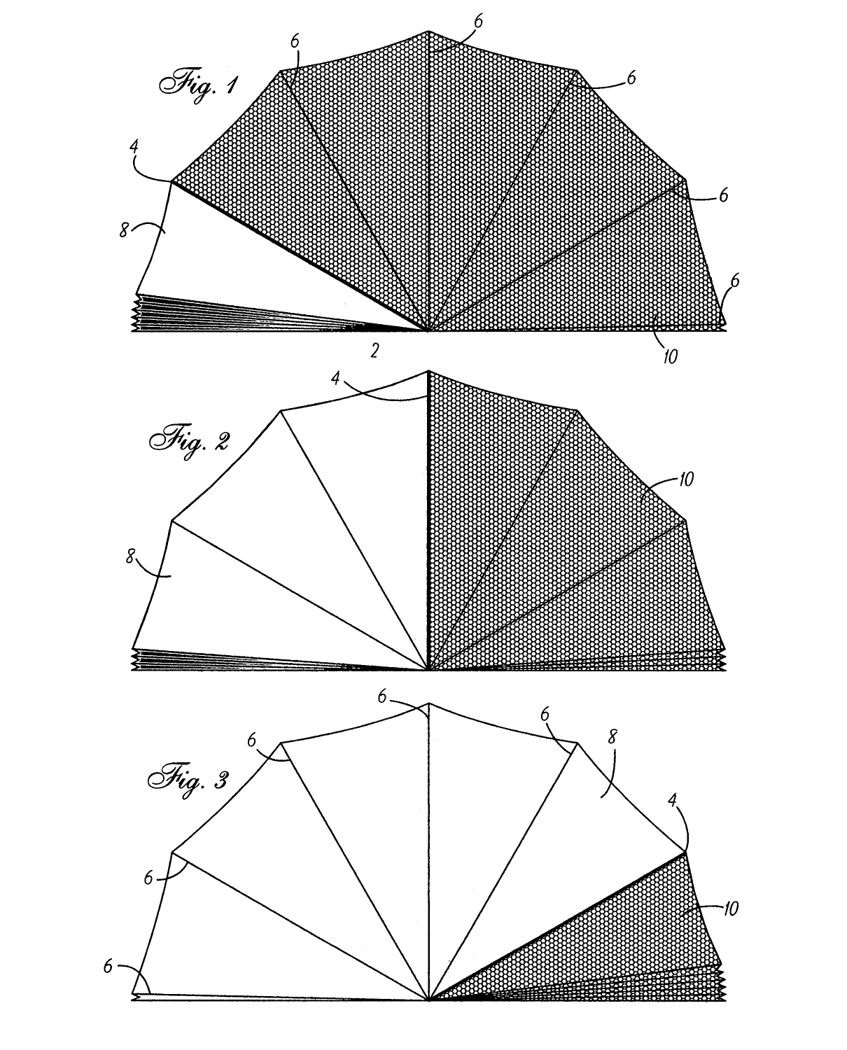

Turning to the drawings, in particular, FIG. 1 which illustrates a rear elevation view of the dome of the plant growth system of the present invention shown in a substantially translucent attitude wherein the dome comprises a center axis 2, a drive arch 4, a plurality of idle arches 6, a translucent sheet covering 8, and an opaque sheet covering 10.

The center axis 2 further comprises a rigid rod rotationally articulated along said rod's longitudinal axis, and drives one arch adaptor at each end of same rod. These driven adaptors accommodate the drive arch 4 so as to sway said drive arch from one side to the other when the rod is rotationally actuated.

Both the translucent and opaque sheet coverings 8 & 10 are seemed together along the length of the drive arch 4, and each end of said sheet covering 8 & 10 distal to the seem is attached to one each idle arch 6, which the weight of said arches 6 holds down the ends of the sheet coverings 8 & 10.

Referring now to FIG. 2, a rear elevation view of the dome of the plant growth system of the present invention shown in a half darkening and half translucent attitude wherein the drive arch 4 has rotated the sheet covering assembly 8 & 10 so as to semi darken the dome space. A plurality of idle arches are attached to the sheet covering 8 & 10 at equal spacing thereby maintaining a rounded shape to form the dome thus increasing the volume within the dome.

Referring now to FIG. 3, a rear elevation view of the dome of the plant growth system of the present invention shown in a substantially darkening attitude wherein the drive arch 4 has rotated the sheet covering 8 & 10 where the opaque material generally covers a semi-spherical portion of the dome shape thereby darkening the dome space. The idle arched 6 simply collect under the drive arch 4 thereby collapsing the transparent portion 8 of the dome.

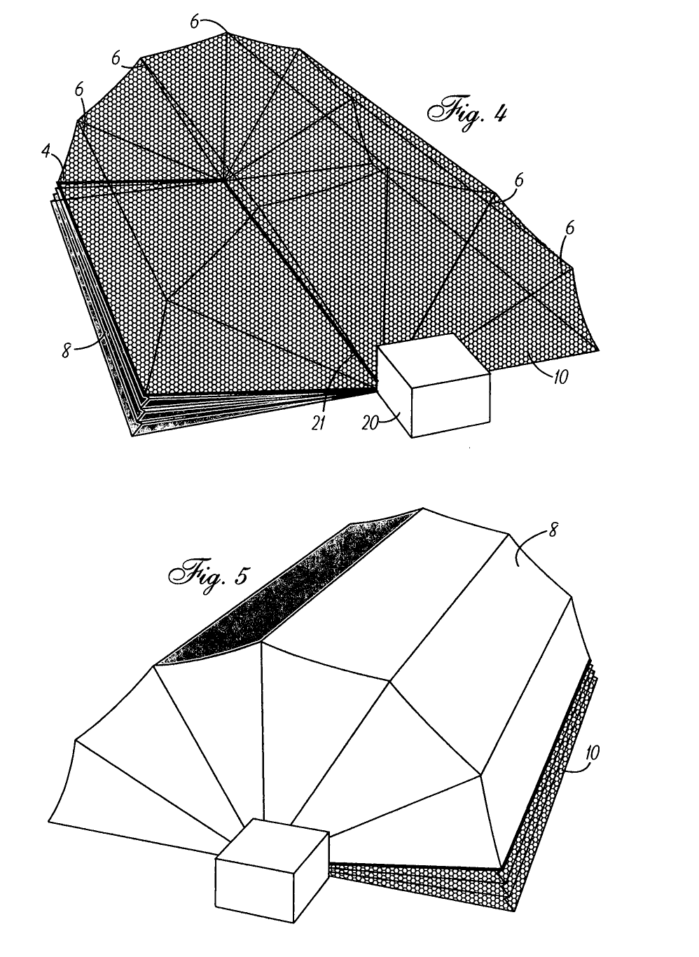

Turning to FIG. 4, a front perspective view from above of the dome of the plant growth system of the present invention shown in a transparent attitude wherein the opaque sheet covering 8 is collapsed and the transparent sheet covering 10 is expanded thus rendering brightness to the inner space of the dome during daylight hours. A drive system 20 engages an actuator to the center drive rod 21, on which all arches 4 & 6 rotate. In remote locations, the actuator is powered by DC battery power charged by means of solar panels. A control device calibrates the exact time the actuator puts the drive arch in motion. Therefore the user can define the length of daylight entering the dome.

In reference now to FIG. 5, a front perspective view from above of the dome of the plant growth system of the present invention shown in a substantially darkening attitude wherein the opaque sheet covering 8 is expanded and the transparent sheet covering 10 is collapsed thus rendering darkness to the inner space of the dome.

The embodiments of the invention in which an exclusive property or privilege is claimed are defined as follows:

1. A plant growth system comprising:
a. a plurality of idle arches,
b. a drive arch,
c. a drive rod,
d. an opaque sheet covering,
e. a transparent sheet covering,
f an actuation system, and
g. a control device.

2. The plant growth system of claim 1 wherein the idle arches are adapted with two each drive rod adapters at each extremity of said arches, and said adapters rotate freely about a longitudinal axis of said drive rod.

3. The plant growth system of claim 1 wherein each idle arch from the drive arch is slightly smaller than the previous arch so as to allow nestling of the arches when said idle arches are collapsed.

4. The plant growth system of claim 1 wherein the idle arches from the drive arch is slightly smaller than the previous arch so as to allow nestling of the arches when said

5. The plant growth system of claim 1 wherein the drive arch is adapted with two drive rod adapters at each extremity of said arch, and said adapters are fixedly positioned onto the drive rod thereby ensuring that the drive arch adapters rotate with the drive rod when rotationally actuated.

6. The plant growth system of claim 1 wherein the drive arch travels 180 arc-degrees from horizontal to horizontal positioning per occurrence.

7. The plant growth system of claim 1 wherein the opaque sheet covering is sufficient in size form and length to cover the depth, side panels and the arc distance of 180 degrees thereof.

8. The plant growth system of claim 1 wherein the transparent sheet covering is sufficient in size form and length to cover the depth, side panels and the arc distance of 180 degrees thereof.

9. The plant growth system of claim 1 wherein the opaque and transparent sheet coverings are seemed together at the mid-line along the length of the drive arch.

10. The plant growth system of claim 1 wherein a timer adjustable by user controls the actuation system.

11. The plant growth system of claim 1 wherein the use thereof is to define the length of daylight received by plants within the dome.
